(19) United States
(12) Patent Application Publication
(10) Pub. No.: US 2004/0044588 A1
(43) Pub. Date: Mar. 4, 2004

(54) Customer recipient list reorder feature for on-line transactions

(75) Inventors: Douglas David Smith, Medford, OR (US); Baokang Chen, Burnaby (CA); Jeffrey Powning Bernard, Ashland, OR (US); Tana Jean Mason, Gold Hill, OR (US); Heidi Irene Flenner, Medford, OR (US); Julie Lynne Derry, Medford, OR (US); Susan Patricia Eagan, Ashland, OR (US)

Correspondence Address: KLARQUIST SPARKMAN, LLP, One World Trade Center, Suite 1600, 121 S.W. Salmon Street, Portland, OR, 97204, US

(73) Assignee: Bear Creek Corporation

(21) Appl. No.: 10/229,932

(22) Filed: Aug. 27, 2002

(51) Int. Cl. G06F 17/60

(52) U.S. Cl. 705/27

(57) ABSTRACT

An on-line editable recipient list is provided to a customer to enhance a reorder process for a list of recipients. The recipient list contains a list of recipients who received products previously ordered by the customer and delivered to the recipients possibly in association with a periodic event (e.g., a holiday). An interactive feature is provided for reordering all the same products for all the same recipients as last year. The customer can start with this list and shop on-line for the customers on the list. In one case, the customer reorders the same products as last year for some recipients on the list, and shops-for new products for other recipients on the list. In one such case, the customer can add, delete and modify recipients from last year's list.

### TECHNICAL FIELD

The invention relates to systems and methods facilitating e-commerce, and more particularly, to the features of an editable reorder list in an on-line transaction.

### BACKGROUND

Organizations have become increasing dependent on computers to maintain high levels of productivity. In some respects these computers can be used to enrich the experiences that customers of the organizations have when acquiring products and services from the organizations.

Some companies are now offering their existing customers and new customers the opportunity to purchase the company's products on-line. One particularly challenging experience for customers relates to making an on-line purchase from a company the customer has known and loved for years. The customer must become familiar with the on-line purchase experience of the company.

Presenting an on-line experience that does not frustrate the customer and that provides immediate value to the customer according to the existing relationship can be challenging. Accordingly, improvements in the field of on-line transactions are needed.

### SUMMARY

An on-line editable recipient list is provided that a customer can use to reorder for a list of recipients. The recipient list contains a list of recipients who received products previously ordered by the customer and delivered to the recipients possibly in association with a periodic event (e.g., a holiday). The customer uses the list to save time during this years shopping experience. In one case, an interactive feature is provided for reordering all the same products for all the same recipients as last year.

In another respect, the editable recipient list contains a list of recipients from a previous transaction between the company and the customer where the previous transaction involved a mail order or a telephone order. The customer can start with this list and shop on-line for the customers on the list. In one case, the customer reorders the same products as last year for some recipients on the list, and shops-for new products for other recipients on the list. In one such case, the customer can add, delete and modify recipients from last years list.

In another respect, an interactive feature allows the customer to browse products while maintaining a shop-for state for a specific list recipient. Upon a product selection, the selected product is associated with the shop-for recipient. In another case, a customer can use another interactive feature to switch between shop-for recipients.

In another respect, a customer can use a recipient write-in feature which adds a recipient to the editable recipient list, and associates the new recipient with the selected product that generated the write-in request. In such a case, the write-in's shipping information can be completed as late as check-out.

In other respects, an interactive feature allows a customer to add recipients to the editable recipient list. For example, an interactive feature allows adding recipients from the customer's address book. Another interactive feature allows a customer to add new recipients to the recipient list. In another respect, additions (and or changes) to a recipient list are automatically added to an address book.

In yet another respect, an interactive feature allows a customer to select and switch delivery dates and methods. In one case, delivery methods or dates are selected for individual products associated with list recipients.

In another respect, a recipient list contains an interactive feature associated with a recipient that reorders last years product for only that recipient. In one case, the reorder product information is transferred into a reorder-this-year field.

Additional features and advantages will be made apparent from the following detailed description of the illustrated embodiment which proceeds with reference to the accompanying drawings.

### BRIEF DESCRIPTION OF THE DRAWINGS

FIG. 1 is an illustration of an exemplary on-line transaction environment.

FIG. 2 is a diagram illustrating an exemplary on-line user interface.

FIG. 3 is a diagram illustrating an exemplary on-line user interface for a user sign-in.

FIG. 4 is a diagram illustrating an exemplary on-line user interface depicting a recipient list interactive feature.

FIG. 5 is a diagram illustrating an exemplary on-line user interface depicting an address book interactive feature.

FIG. 6 is a diagram illustrating an exemplary on-line user interface depicting interactive features of an address book.

FIG. 7 is a diagram illustrating an exemplary on-line user interface depicting a seasonal shopping interactive feature.

FIG. 8 is a diagram illustrating an exemplary on-line user interface depicting a product selection and customer write-in interactive features.

FIG. 9 is a diagram illustrating an exemplary on-line user interface depicting a shopping basket interactive feature.

FIG. 10 is a diagram illustrating an exemplary on-line user interface depicting a check out interactive feature.

FIG. 11 is a diagram illustrating an exemplary on-line user interface depicting a recipient change form interactive feature.

FIGS. 12-13 are a diagram illustrating an exemplary on-line user interface depicting a recipient list and associated interactive features.

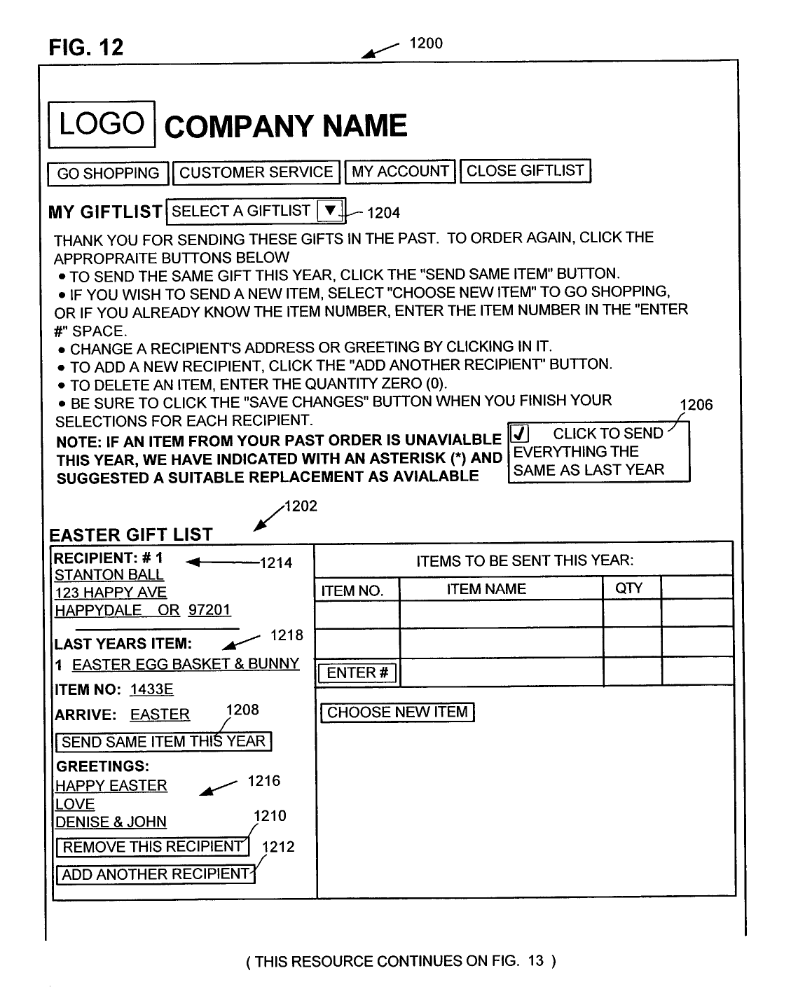

FIG. 14 is a diagram illustrating an exemplary on-line user interface depicting a change recipient list interactive feature.

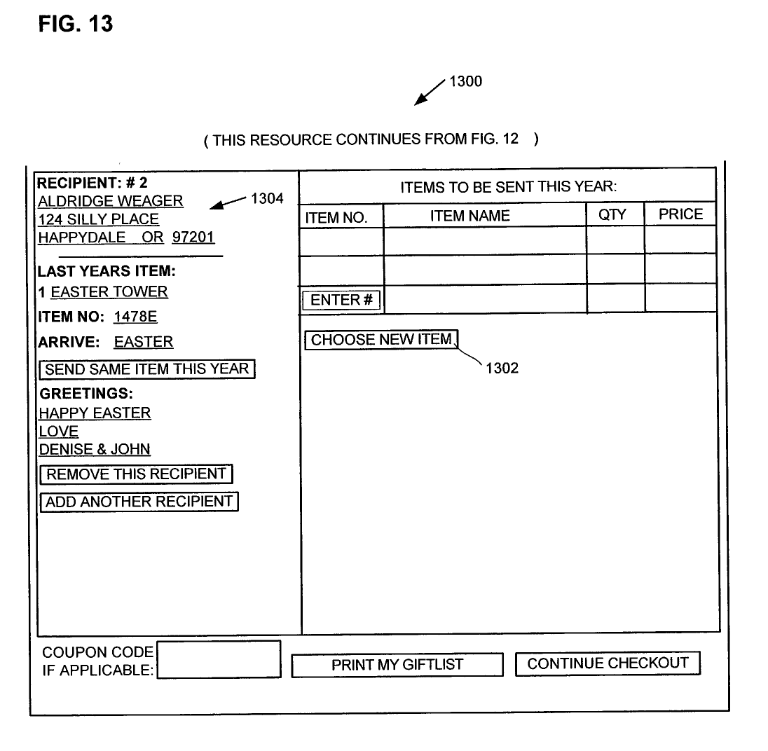

FIGS. 15-16 are a diagram illustrating an exemplary on-line user interface depicting a recipient list and associated features.

FIG. 17 is a diagram illustrating an exemplary on-line user interface depicting a shopping basket and associated interactive features.

FIGS. 18-19 are a diagram illustrating an exemplary on-line user interface depicting a recipient list and multiple interactive features.

FIG. 20 is a diagram illustrating an exemplary on-line user interface depicting a shopping resources and a shop-for change interactive feature.

FIG. 21 is a diagram illustrating an exemplary on-line user interface depicting a recipient cell and suggested product interactive feature.

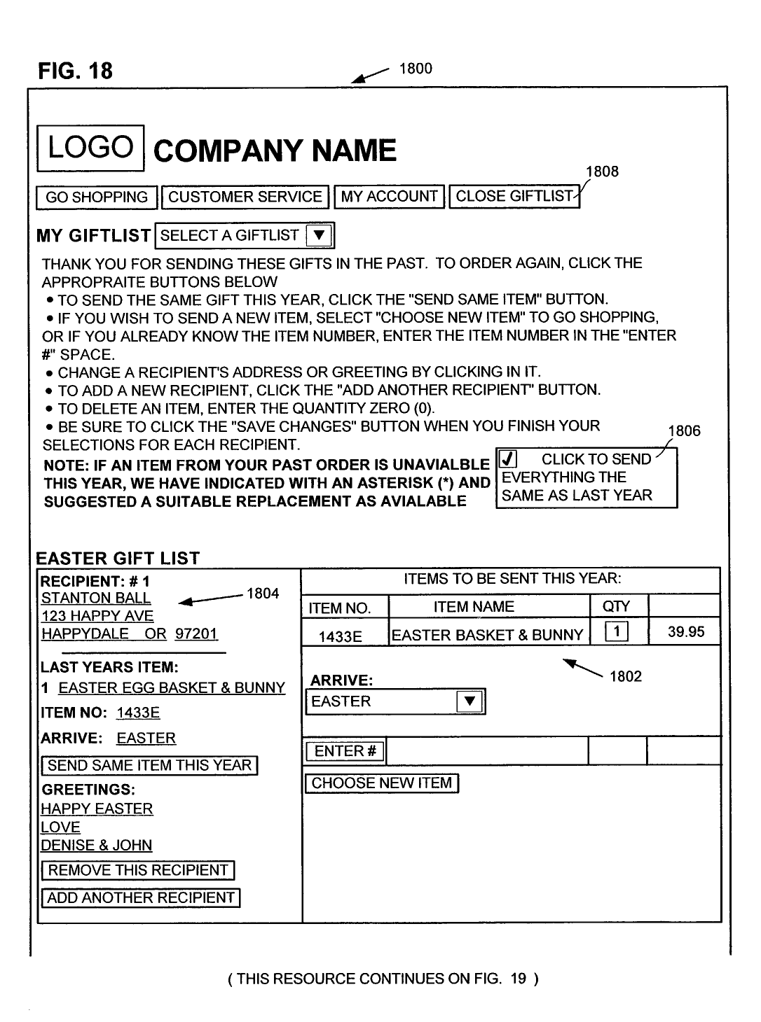

FIG. 22 is a diagram illustrating an exemplary on-line user interface depicting a recipient cell with an enter product item number interactive feature.

FIG. 23 is a diagram illustrating an exemplary on-line user interface depicting a recipient cell with a change arrival date interactive feature.

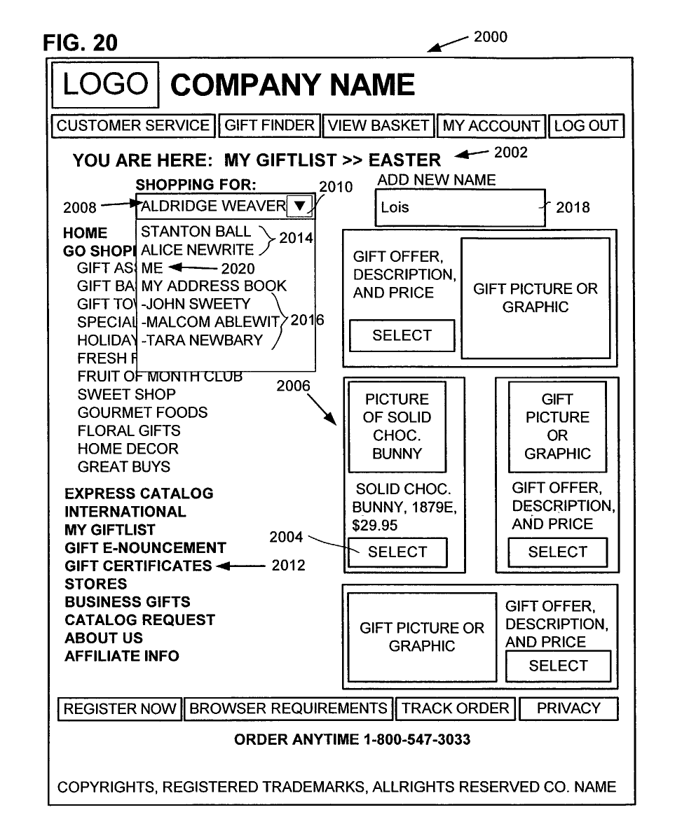

FIG. 24 is a diagram illustrating an exemplary on-line user interface depicting a recipient cell with a change date pull-down interactive feature.

FIG. 25 is a diagram illustrating an exemplary on-line user interface depicting a recipient cell with a message indicating a desirable delivery method.

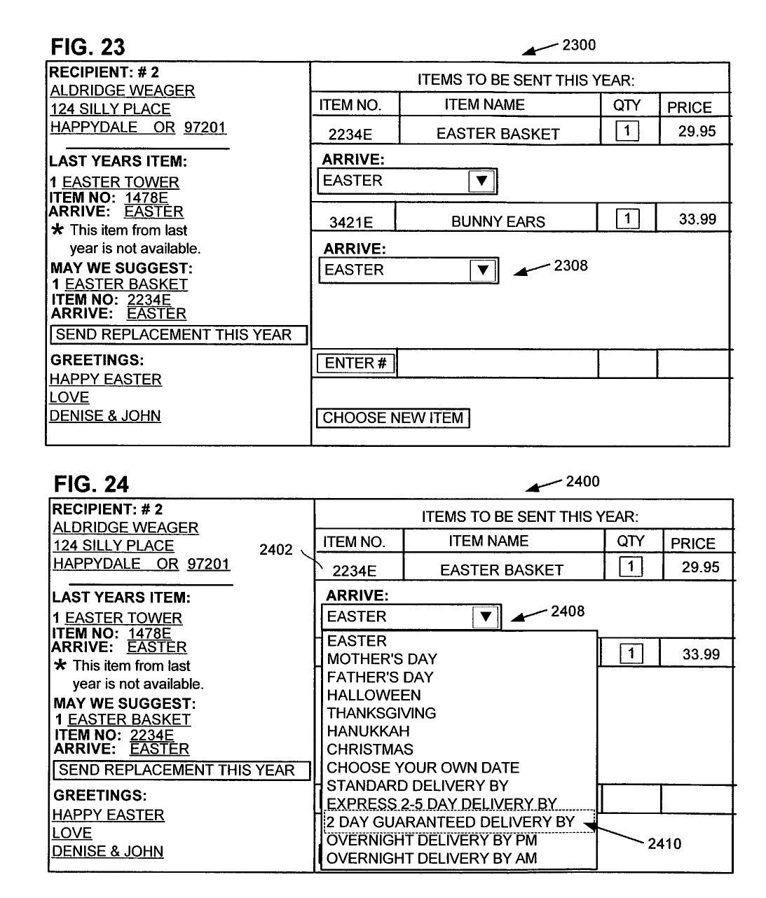

FIG. 26 is a diagram illustrating an exemplary on-line user interface depicting a recipient cell with a delivery date interactive feature.

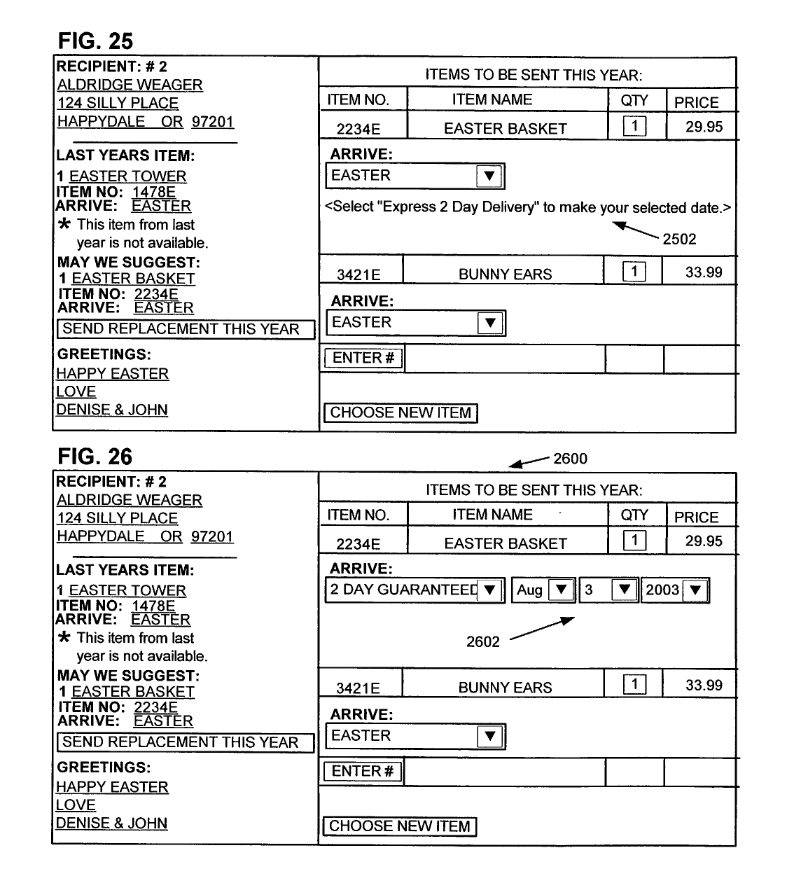

FIG. 27 is a diagram illustrating an exemplary on-line user interface depicting a recipient cell with a choose your own date interactive feature.

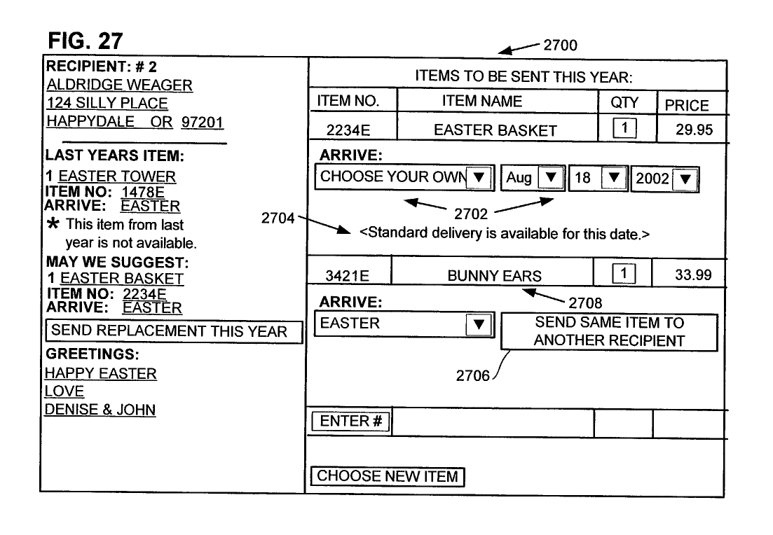

FIG. 28 is a diagram of an in-memory exemplary web page template populated with customized content.

FIG. 29 is a diagram illustrating an exemplary on-line user interface depicting a rapid reorder implementation.

### DETAILED DESCRIPTION

In the following detailed description, one implementation of a recipient list reorder feature according to the invention is embodied in an on-line transaction.

### Products and Services

An entity such as a corporation, an organization, or an individual (i.e., a company) markets and or distributes products and or services (i.e., products) to other such entities (i.e., customers). In one example, the products are holiday related gifts and or consumer goods (e.g., gift baskets, candy, holiday food items, plants, garden items, gifts, etc.), and the customers are the general public and other entities.

The company offers the products through a number of marketing channels including a catalogue which is mailed to customers. In one case, a customer purchases the products advertised in the catalogue using a mail-order purchase; in another case, a customer calls a call center or sales representative (e.g., via a telephone number) and orders the products advertised in the catalogue. The catalogue includes products, products arranged in categories, product descriptions, product pictures, product promotions (e.g., 2 for 1, 20% off, holiday discounts, seasonal discounts, early bird specials, etc.), coupon numbers and product item numbers.

In one case, products selected from a catalogue are purchased by the customer, for the customer, and are shipped to the customer. In other cases, products are purchased by the customer, for other entities, and are shipped to the other entities (i.e., recipients). In one such case, the customer is purchasing products for recipients in relation to some periodic event. Exemplary periodic events would include holidays (e.g., Christmas, Hanukkah, Easter, Halloween, New Years, Fathers Day, etc.), seasonal events (e.g., harvest, spring, winter, etc.) or personal events (e.g., birthdays, anniversaries, etc.).

In the case of mail order, the customer fills out a purchase form including product identification numbers, prices, shipping costs. The form is mailed (or faxed) to the company including payment in the form of a credit card authorization, money order, etc.

In the case of telephone purchase orders, the customer calls a company representative and makes a verbal purchase order including payment information (e.g., credit cards or other payment methods). Customers verbally identify selected products by a remembered product name, a catalogue page number, or a product item number from a catalogue. In another case, the customer visits a company retail outlet and purchases the products in person. In case of mail order, telephone order, or retail outlet purchase, the purchasing customer can identify a recipient name and mailing address where a selected product should be shipped.

### Event Catalogues

In one example, a catalogue has a holiday or other periodic event focus. In such a case, a customer selects products (e.g., gifts) from the holiday catalogue and sends them to recipients for the holiday season. The identification of holiday products and associated recipients is made by a customer using the above described mail order, telephone order, or a retail outlet order methods.

A year later, the company sends the customer another catalogue for the same periodic holiday event. However, along with the holiday catalogue, the company mails the customer a list of the recipients who the customer ordered products for last year. The customer may use this list to save time.

For example, for the mail order method, the customer adds product item numbers to the pre printed recipient list and returns the list to the company with payment instructions. For the telephone order, a customer tells the telephone operator what products to send to each recipient on the list. In an additional implementation, a customer delivers the list to a retail outlet including product item numbers for each recipient on the list. In such a retail outlet implementation, customer telephone numbers, house accounts, house credit cards, and other identifiers can be used for purchase tracking. In all three cases, a customer may elect to send the same product as last year to the same recipients as last year.

### E-commerce Environment

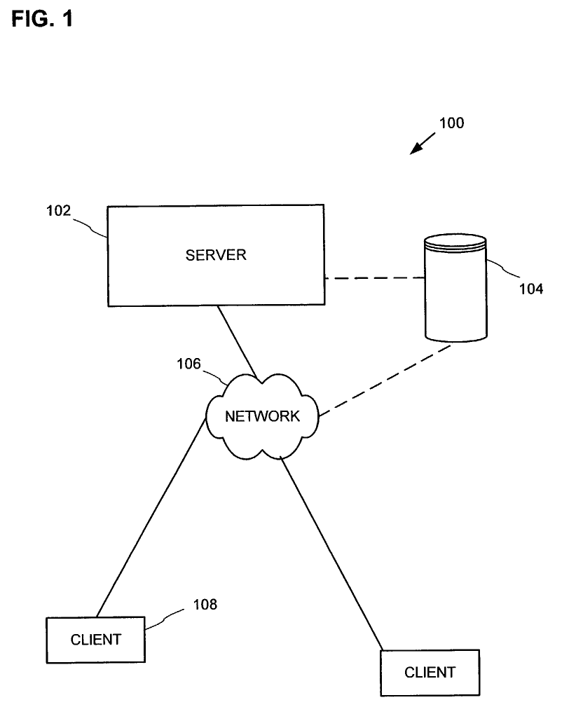

FIG. 1 shows portions of an exemplary client-server arrangement 100 that can be used to support e-commerce product sales. For example, a server computer 102 has a database 104 which includes a record of previous transactions made by a customer and available products. Information about previous transactions made through mail order, telephone order or retail order are contained in a database 104 including recipient lists. Much of this information is valuable to a customer and enhances the on-line experience. The server computer 102 receives network requests (e.g., HTTP requests) from plural client devices 108. The server provides network resources in response to the clients requests. These resources can be delivered based on any distributed application known in the computing arts. Preferably the server will support a widely utilized communication protocol since more client devices will be able to communicate with the server. Such widely used protocols are TCP/IP, HTML, XML, WSDL, and etc.

In one case, the server supports delivering network resources in the form of web pages including graphics, text, fields, pictures, buttons, textual links, icons, banners, etc. The web pages include descriptions of products and services available through the company. The server may include server farms and distributed sites and resources, multiple servers, and distributed databases. A client device includes personal computers, thin client devices, personal digital assistants, cell phones, portable computers, set top boxes, and etc. The client devices preferably support graphical user interfaces for browsing the network resources.

A user interface can be a client side application, a web page displayed in a network browser, or a non-hypertext based user interface. A graphical features includes graphics, text, fields, pull down menus, radio buttons, icons, animated graphics, video, audio, slide shows, cartoons, and many other graphical features known in the computer arts. Some of the graphical features in the user interface are interactive features (e.g., an interactive feature receives customer selection or other input). Customers use a mouse, keyboard or other input devices to interact with the interactive features of the graphical user interface.

The customer selects interactive features using a mouse, a keyboard, or other input device to move the cursor on screen, to activate text and graphics, and to type text or make other interface control selections. A customer selects an interactive feature or types text into an interactive feature to interact with the user interface. In some cases, a message is sent to the server in response to such interaction with the user interface. For example, by selecting a text interactive feature, a request for a web page resource is often sent to the server. The server may respond, for example, by returning another resource to the client device. In such a case, a returned resource includes web pages, information, graphics, pictures, audio, video, or text presented to the customer at a client device after resources are received from the server.

### Exemplary User Interface

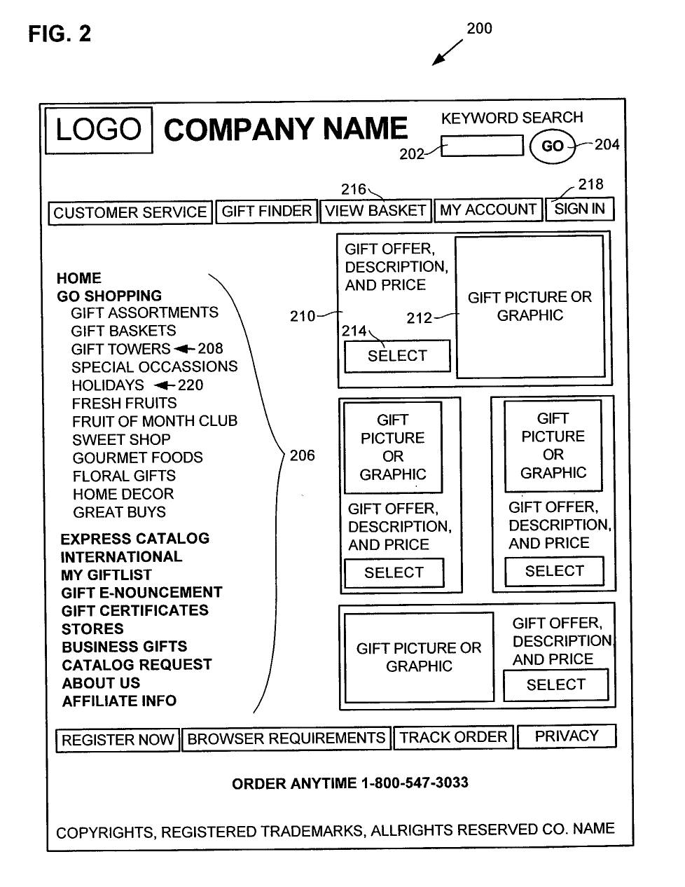

FIG. 2 shows an exemplary resource comprising a diagram of a user interface 200 presented to a customer on the client device in response to accessing the server. From this user interface, a user may begin browsing other user interface resources provided by the server.

The user interfaces 200 presented at the client device includes interactive features. For example a user may type in a keyword in a character field 202 and select Go 204 to commence a search for specific information. A keyword index resource is maintained at the server, and a list of resources (not shown) are returned by the server to the client device in response to the keyword search request.

The user interface includes interactive text 206, so a customer can select other resources provided by the server. For example, when a customer selects a shopping category (e.g., gift towers 208), the client device sends a request for and receives from the server, a resource including products in the selected category.

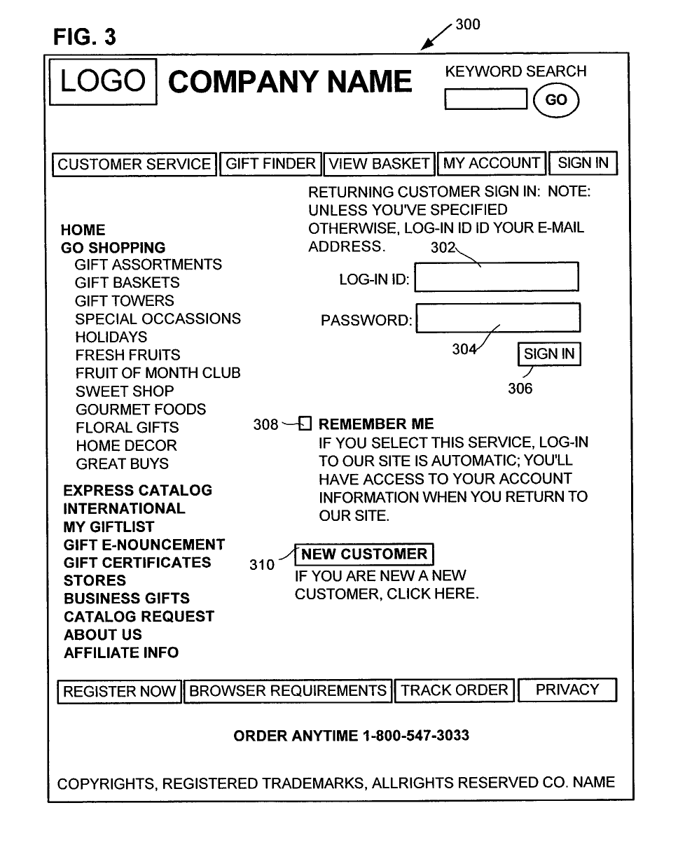

In one case, a user interface 200 includes an initial product(s) offering 210 from the company which includes a product offer, a description, a product item number and/or a price, and possibly a graphical feature or other product representation 212. In such a case, the product offering includes an interactive feature 214 that a customer uses to select a product purchase. In one case, an interactive feature 214 contains text or other representations. Preferably, the text or other representations signal to the customer a function of the interactive feature (e.g., “add to shopping basket”). Upon a product selection, state information is maintained indicating the desired product. For example, a customer obtains state information about products already selected by the customer using an interactive feature 216 which returns a resource including state information about already selected products. The user interface includes an interactive feature that a customer selects to “sign in” 218. When the customer selects the sign-in interactive feature 218, they are presented another user interface (e.g., FIG. 3).

FIG. 3 shows an exemplary sign-in user interface 300 presented to the customer. The customer enters their log-in identification 302 (e.g., e-mail address) and a password 304, and then selects a sign-in interactive feature 306. A message is returned to the server to verify the customer's identity. An existing customer (or a new customer after completing registration) may also select an interactive feature 308, so they can skip this log-in step in the future. Upon selecting the remember-me interactive feature, the server installs a sign-in script (e.g., a cookie data structure) on the client that is used to automatically identify the customer the next time the customer browses to the company web site.

If the customer is a new customer, they select an interactive feature 310 that is used to generate a resource for establishing a customer identity. For example, the resource contains interactive features requesting the new customer to create a log-in name and password for future sessions. In another case, the new customer resource also includes an interactive feature that activates the remember-me feature for the new customer for feature visits to the company web site.

Once the remember-me feature is selected by a new or existing customer, upon a next visit to the company web site by the customer when using the client device, the cookie data structure is used to identify the customer without requiring the customer to complete a log-in identification 302 or password 304 interactive feature.

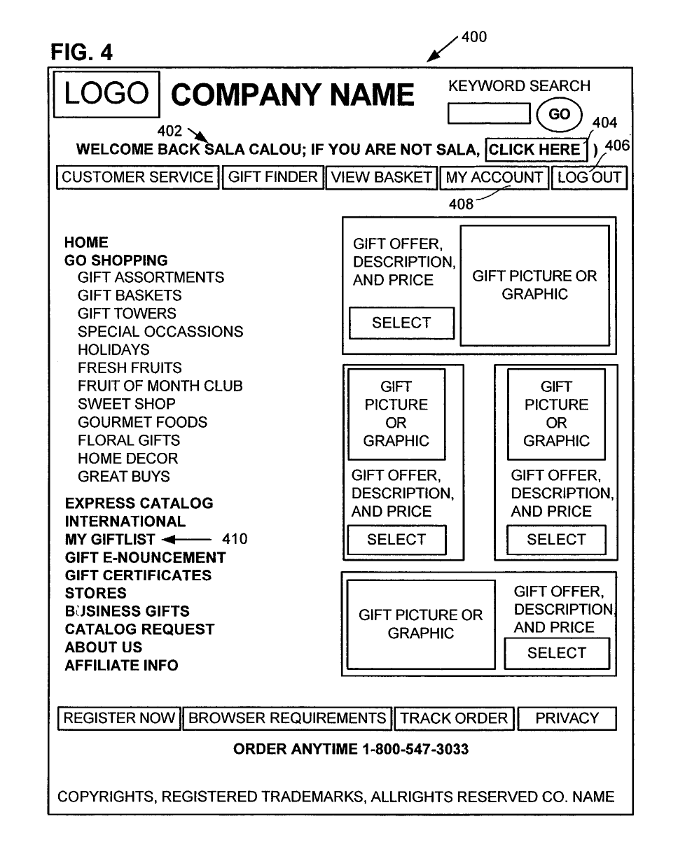

In such a case, upon a next visit to the server resource, a user interface 400 greets the customer by name 402 as shown in FIG. 4. The exemplary user interface includes an interactive feature 404 that a customer can select if the greeting is directed to the wrong customer. This may happen for example, if plural customers obtain access to server resources using the same client device. In such a case, the customer is presented with a sign-in resource (e.g., 300). The exemplary user interface 400 includes an interactive feature 406 that a customer may use to log out.

An exemplary user interface 400 includes an interactive feature 408 that a customer may use to obtain information about the status of the customer's account. Upon selecting this interactive feature 408, if the customer hasn't already signed on, the customer will be presented with a sign-in user interface (e.g., FIG. 3). In one case, when account information is requested, the remember-me feature is used to eliminate the sign-in requirement. In the present implementation, credit card numbers and information is not maintained by the company and is entered again by the customer during a next purchase transaction. However, in another implementation, credit card information is stored as a convenience to the customer. In such a case, even if the remember-me feature is selected, a password may be required before any credit card information is displayed to the customer. In any such case, once the customer is identified, and in response to the “my account” interactive feature selection 408, they are presented with account information.

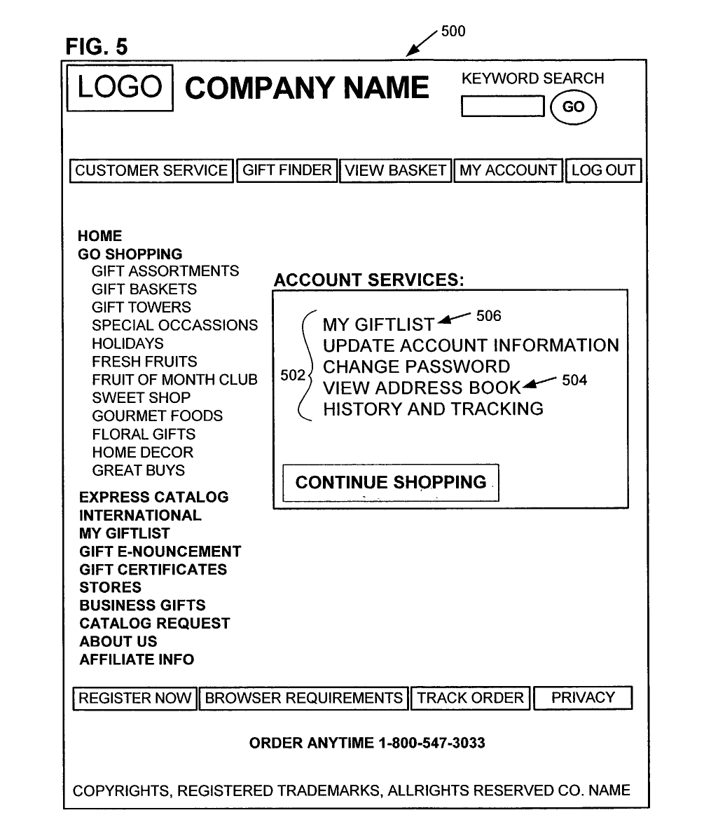

An exemplary user interface 500 of containing account information options is depicted in FIG. 5. For example, interactive features 502 are presented to the customer which allow the customer to request information about or make changes to their account. For example, the customer may select interactive features that return other resources containing interactive features for viewing or changing account information. Exemplary returned resources provide such functionality as changing a password, changing a customer mailing address, viewing orders, viewing previous purchases, viewing previous recipients of specific items, viewing an address book of individuals previously sent products by the customer, and viewing lists of products previously sent by the customer to recipients (e.g., a holiday gift list).

When a new customer signs on 310 for the first time, their name is compared with the names in the database. If the customer has ordered before using the mail order method or the telephone order method that information is associated with the new e-commerce account and provided by the server upon customer request. In an alternative implementation, transactions made at a retail outlet by an identifiable customer, are also associated with the e-commerce account. For example, in one case recipients of those prior transactions appear in the customers on-line address book 504. In another case, other account information 502 is provided to the customer.

Upon selecting an interactive feature 504, the customer is presented with a user interface including a list of entities (e.g., friends, business associates, or corporations, etc.) in a customer's address book.

### Exemplary Customer Address Book

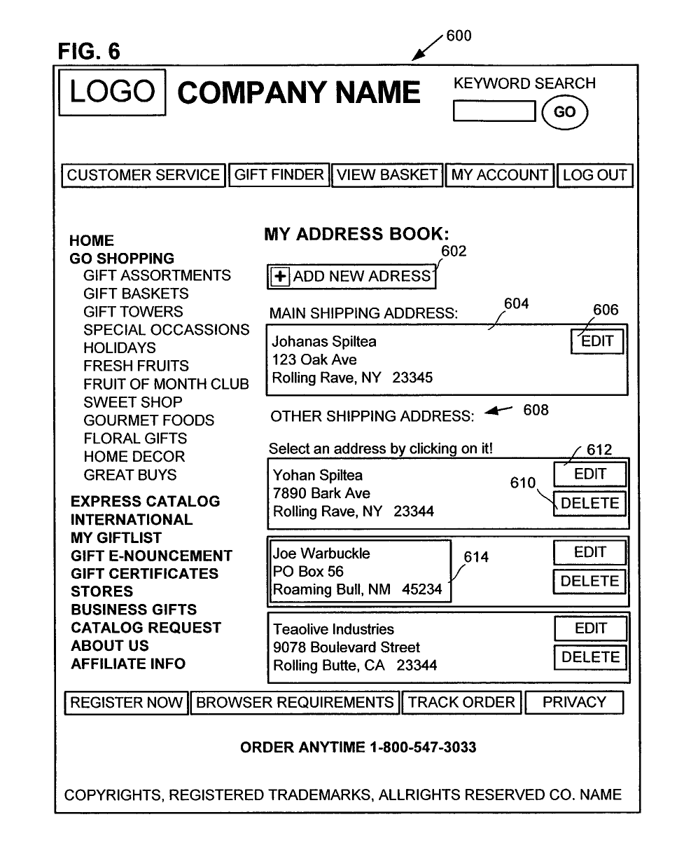

FIG. 6 shows an exemplary user interface 600 including a customer address book. In this example the address book includes graphical features such as the customers address 604 and/or a list of other address where the customer has or may in the future want to ship products 608. The user interface 600 also includes an interactive feature 606 for changing the customer address, adding new entities 602, changing entity addresses (or names) 612, and for deleting entities from the address book. These entity addresses are assembled at the customer's convenience by the company from previous orders made by the customer (e.g., mail order, phone orders, and e-commerce orders). These entity addresses are assembled and returned to the customer in the customer address book user interface 600.

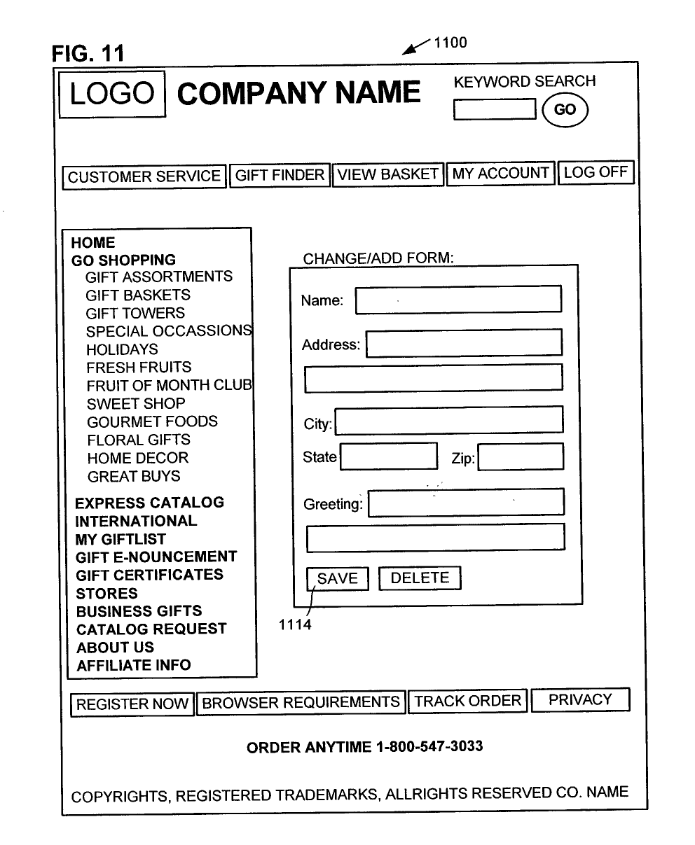

This address book may also be expanded 602 or edited 606, 612 by the customer using keyboard entry. For example, if a customer selects an interactive feature for editing 612 an entity name or address (or adding a new entity 602), a resource is returned (e.g., FIG. 11) including interactive fields for changing (or adding) the entities name or address, including an interactive feature for saving the changes to the address book. In one case, as the customer orders from the company, whether by catalogue mail order, catalogue telephone order, or e-commerce order, this address list is built and provided to the customer. For example, this information is merged into the customer's address book. In one such case, this information is maintained in two or more databases, and is not merged and available to the customer until a monthly, annual or other periodic merge. In other cases, the information is available to the customer sooner, for example, when it is maintained in a single database, when it is entered via an e-commerce resource, or when a database merger is caused more often (e.g., upon completion of an order). In one such case, the address list grows when addresses are added by the customer using the interactive feature 602, even when no product is ordered for an added entity.

### Product Oriented Shopping

In one example, a customer selects a periodic event, then browses products available to send in association with the periodic event. Once the customer has selected a product, the customer selects one or more recipients for the selected product. After selecting recipients, the customer checks out and the company sends the gifts accordingly. For example, a customer may decide to send holiday related gifts to recipients (e.g., Halloween, etc.). Once the process is complete, the customer has created a periodic (holiday) event recipient list. In this case, the periodic event list was created in a product oriented shopping way. This periodic event recipient list is later used, for example, as discussed in “Recipient List Oriented Shopping.”

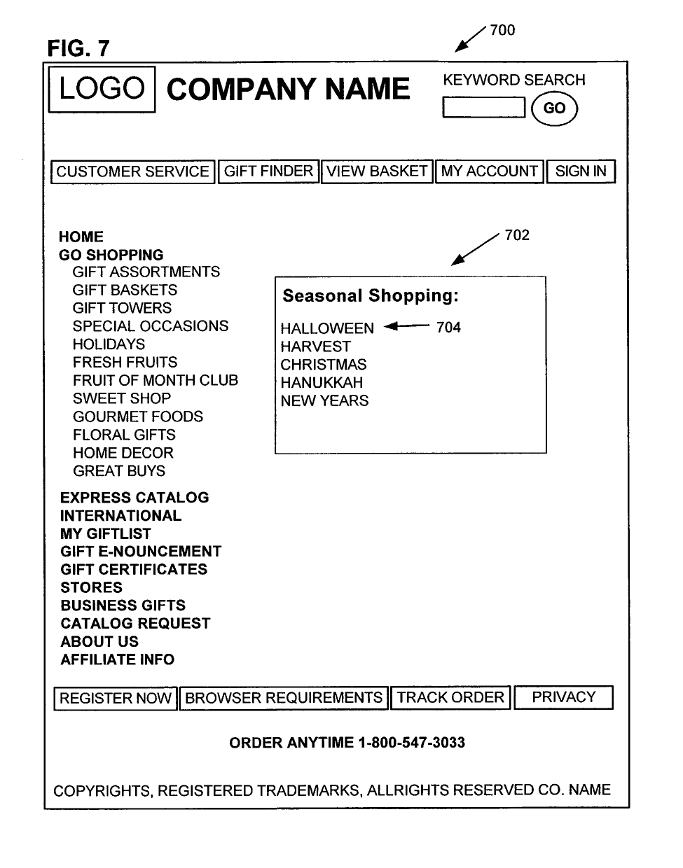

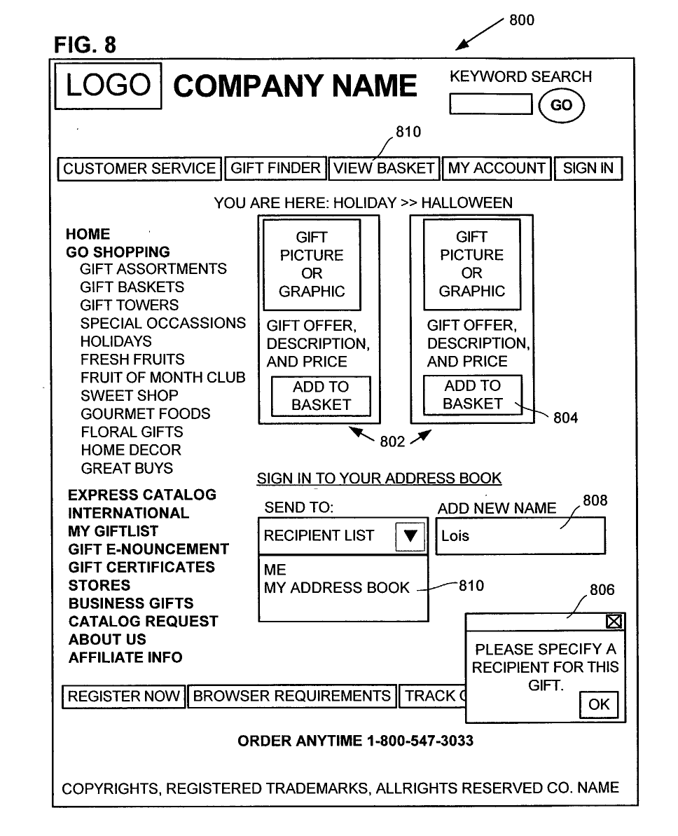

In one case, a customer browses to the company web site and selects an interactive feature (e.g., 220, FIG. 2) indicating a periodic holiday event. The customer is returned a resource 700 offering plural periodic holiday event selections 702 as shown in FIG. 7. After the customer selects an interactive feature 704 representing a periodic event (e.g., Halloween), a resource(s) is provided including products selectable for the periodic event. For example, a web page(s) 800 containing product(s) 802 for selection are presented to the customer as shown in FIG. 8.

Notice that in this scenario, the customer has not yet signed onto the company web site. A given implementation may require a customer to sign in at any time. For example, the system may require the customer to sign-in early in this periodic event process, at the time of a product selection, or at periodic event transaction check out. Further, the customer may already be known by the sever if the remember-me feature was enabled by the customer in a previous session.

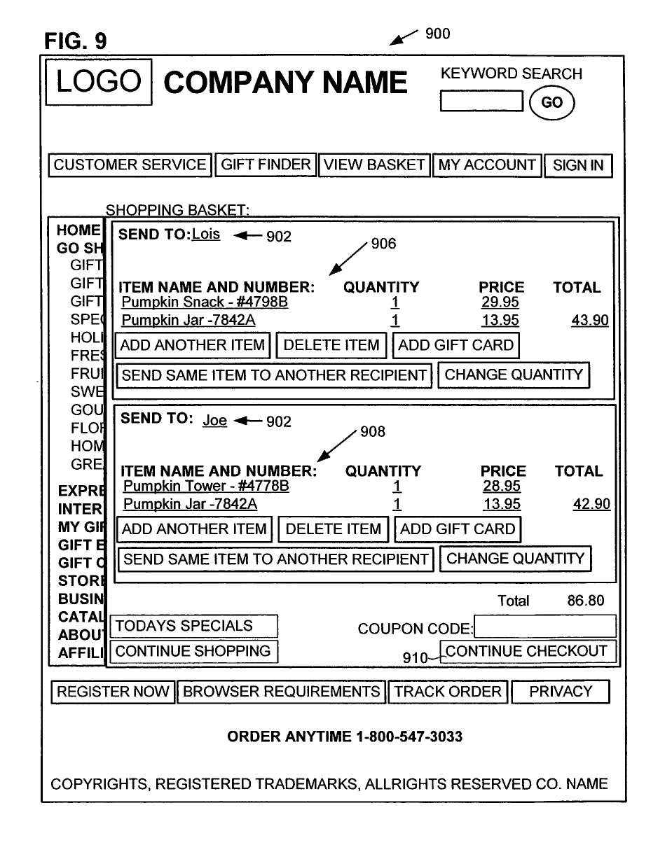

For example, if the customer selects an interactive feature 804, representing a product selection (e.g., a Pumpkin Snack—#4798B), in one case, a pop-up window 806 signals to the customer to select a recipient for the gift. In this case, if the customer writes a recipient's name (e.g., Lois) into an interactive feature 808, the product selection and write-in name will appear later at the periodic event check out. For example, after several product selections and recipient name write-ins 808, the user selects an interactive feature representing a shopping basket 810. A resource 900 is then presented to the customer showing the selected products and associated recipient write-ins as shown in FIG. 9.

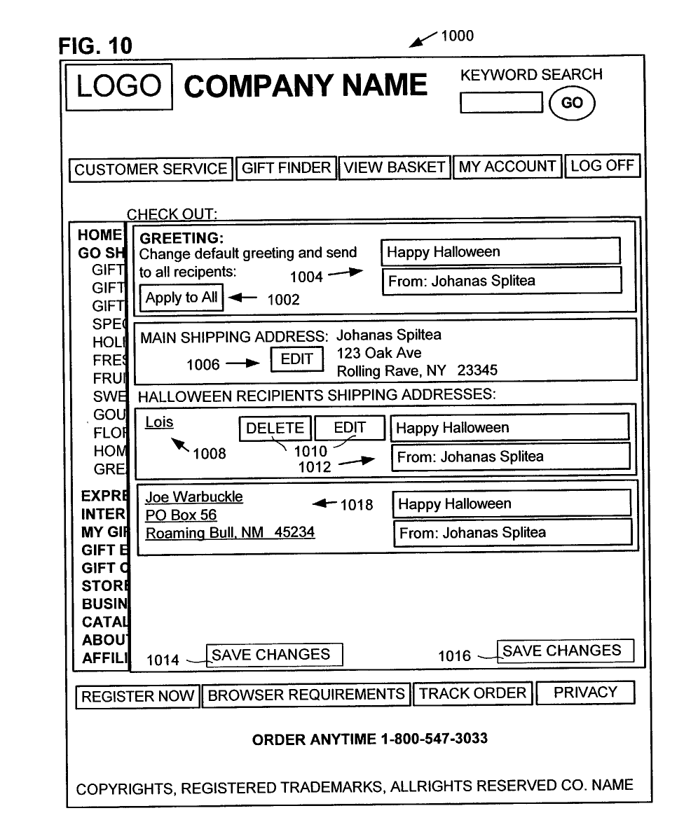

In this case, the write-ins “Lois” 902 and “Joe” 904 appear in the shopping basket with their associated product selections, respectively 906, 908. In this example, if a customer then selects an interactive feature 910 indicating a desire to check out, the system then requires the customer to sign-in or to register as a new customer as shown in FIG. 3. After the customer sign-in (or new registration), a resource is presented to gather shipping information for the write-in recipients from the periodic event associated selections. An example resource 1000 for gathering periodic event transaction recipient shipping information is shown in FIG. 10. For example, the customer can select an interactive feature 1002 to apply a standard greeting to all periodic event recipients, which transfers the default message to all recipients (e.g., 1012). Or, the customer can select an interactive feature 1004, and type in a customer greeting into a field, and then apply 1002 the altered customer greeting to all periodic event recipients.

Next, the customer can select an interactive feature 1008 representing a periodic event recipient and make in-place changes to the recipients name and shipping address. In another case, the customer can make an interactive feature selection 1010 and a resource 1100 is provided for making changes as shown in FIG. 11. Once changes have been completed to recipient shipping addresses, they can be saved individually 1114, or collectively 1014.

After shipping addresses are completed for the recipients of the periodic event transaction, the customer is provided with a resource (not shown) for selecting shipping method and dates, and for making payment arrangements (e.g., credit card, or other electronic payment systems, etc.).

In this example, a recipient list (e.g., Lois and Joe) was created for a periodic event (e.g., Halloween).

### Product Oriented Shopping—An Address Book

In one example, a customer selects a periodic event, then browses products available to send in association with the periodic event. Once the customer has selected a product, the customer selects one or more recipients for the selected product. In this example, the customer either selects a recipient from their address book or creates a new recipient. Once the process is complete, the customer has created a periodic (holiday) event recipient list. In this case, the periodic event list was created in a product oriented shopping way.

In this case, a customer browses to the company web site and selects an interactive feature (e.g., 220, FIG. 2) indicating a periodic holiday event. The customer is returned a resource 700 offering plural periodic holiday event selections 702 as shown in FIG. 7. After the customer selects an interactive feature 704 representing a periodic event (e.g., Halloween), a resource(s) is provided including products selectable for the periodic event. For example, a web page(s) 800 containing product(s) 802 for selection are presented to the customer as shown in FIG. 8.

In this scenario, when a customer selects an interactive feature 804 representing a product, the system either remembers the customer with the remember-me feature or requires the customer to sign-in as shown in FIG. 3.

Under this scenario, the system is able to provide the customer with access to that customer's address book 810. In this case, when a customer makes a product selection 804, the system asks the customer for a recipient name 806. The customer can select the “my address book” interactive feature 810 and will be provided with a copy of their address book (e.g., FIG. 6). If the recipient is in the customers address book, the customer can just click on the recipients name 614, and that recipient's shipping information will automatically populate the shipping information for that recipient in the recipient list 1018 as shown in exemplary FIG. 10. This feature is helpful, especially in cases when recipients have been assembled in the customer's address book from previous transactions (e.g., mail order, telephone order, retail outlet order, or previous e-commerce orders).

Of course, the customer can make new recipients additions in this periodic event transaction using the add name interactive feature 808 previously discussed.

After shipping addresses are completed for the recipients of the periodic event transaction, the customer is provided with a resource (not shown) for selecting shipping method and dates, and for making payment arrangements.

In this example, a recipient list (e.g., Lois and Joe) was created for a periodic event (e.g., Halloween, Birthday, etc.) using the add name feature and the my-address book feature.

### Recipient List Oriented Shopping—Send the Same as Last Year

In this example, a customer selects a periodic event recipient list previously created by the customer, and uses the list to reorder for the same periodic event. In this case, the customer sends the same periodic event gifts to the same recipients as last year.

In this case, a customer browses to the company web site, and since the remember-me feature was enabled in a previous session, the server welcomes the customer (e.g., 402, FIG. 4). In another case, the customer completes a sign-in resource (e.g., FIG. 3).

Next, the customer selects an interactive feature 410 which represents an indication that the customer wants to begin shopping using a recipient list created from a previous periodic event transaction. In one case, a resource is returned which offers the customer plural selectable periodic event lists to choose from (e.g., 702, FIG. 7). In another case, a periodic event list is returned based on the season (time of year) the customer selects the interactive feature 410. In this example, a resource 1200 is returned to the customer which includes a previous periodic event list transaction (gift list) 1202, but also includes an interactive feature 1204 for selecting other previous periodic event lists. In response to selecting the interactive feature 1204, a resource 1400 is presented with an interactive feature 1402 the customer can use to select other periodic event lists. In this example, the customer stays with the default list 1202.

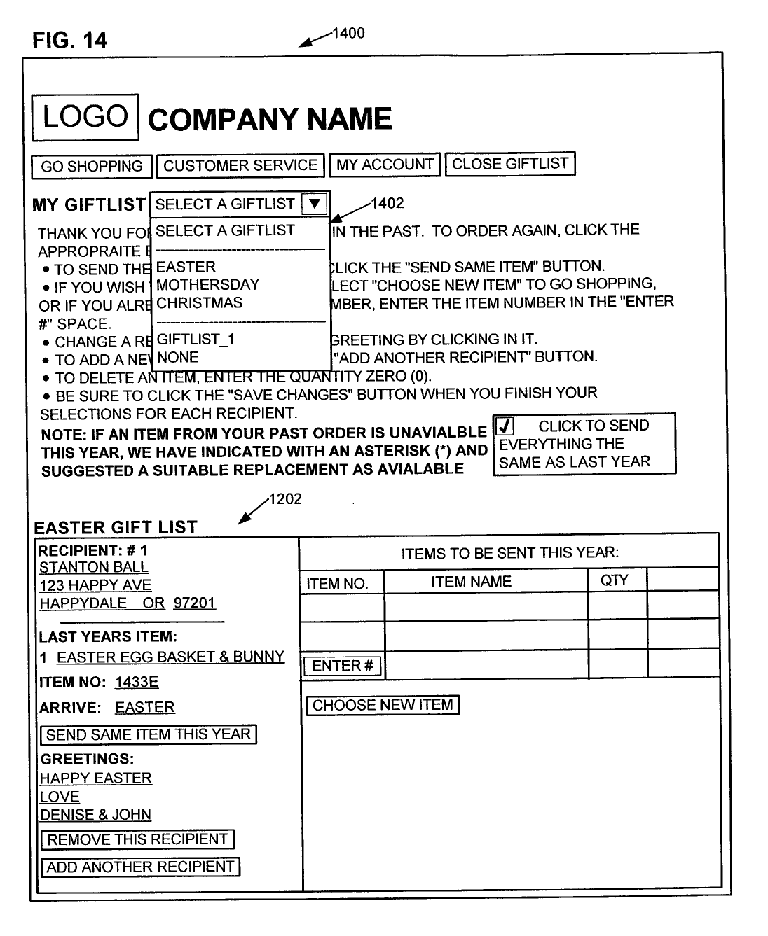

In this case, the customer views the recipient list 1202 and decides to send the same products to the same recipients as last year. The customer selects an interactive feature 1206 which indicates the customer's desire to “send everything the same as last year.” In this case, as shown in FIGS. 15-16, the products sent last year are transferred into the fields for products to send this year 1502, 1602, and the interactive feature 1206 is converted to an interactive feature that a customer uses to “continue checkout” 1506.

If for any reason, the order can not be completed for any recipient in the list, a message is displayed for that recipient 1504, 1604. For example, a message may indicate that an order may not be completed the same as last year because a product is sold out or discontinued, a delivery date is too soon given the address of the recipient, or a requested deliver date is too soon for a standard delivery method, etc. These issues are handled for each message generated for any given recipient before proceeding to check out.

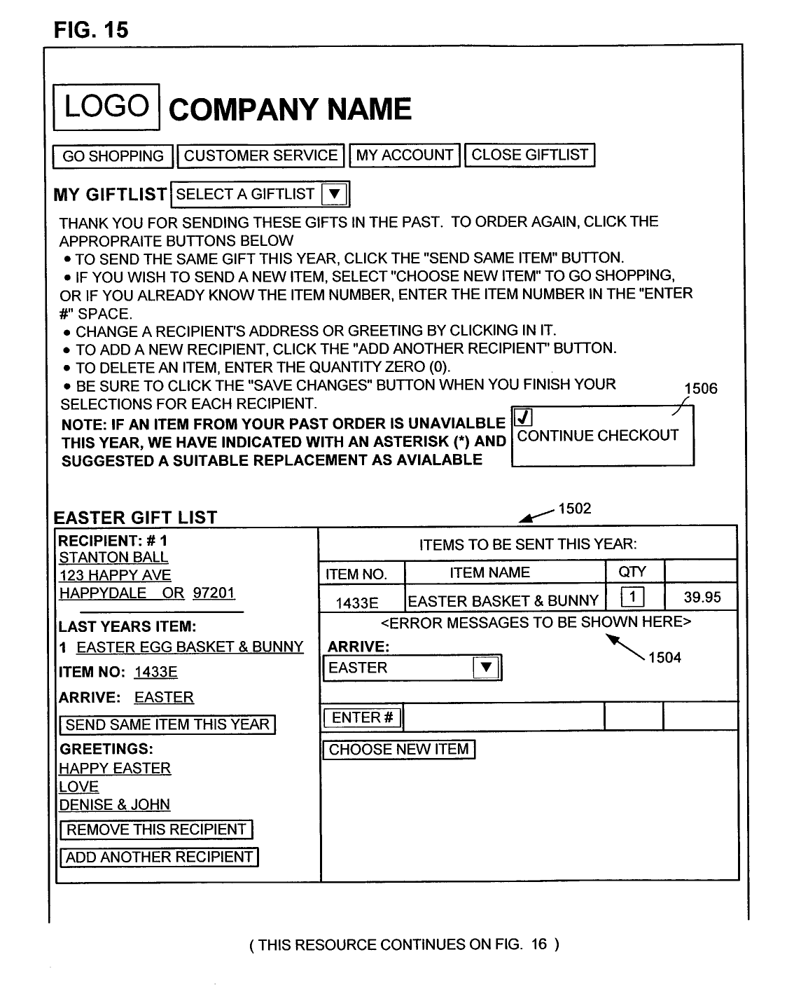

Next, the customer selects the interactive feature 1506 which indicates a desire to “continue checkout.” The customer is presented with a resource 1700 that allows the customer to complete the recipient list reorder transaction as shown in FIG. 17. In this case, the customer completes an interactive feature 1702 field identifying credit card information and then clicks the transaction submit button 1704. In an alternative implementation, the resource 1700, already includes from a previous transaction the credit card information in the interactive feature fields 1702, and the customer just selects the submit button 1704.

### Recipient List Oriented Shopping—Changes Before Reorder

In this example, a customer starts with a previous recipient list associated with a previous periodic event transaction, and makes changes to the recipient list before submitting the reorder. This example discusses changes that can be made to the recipient list.

In this case, a customer browses to the company web site, and since the remember-me feature was enabled in a previous session, the server welcomes the customer (e.g., 402, FIG. 4). In another case, the customer completes a sign-in resource (e.g., FIG. 3).

Next, the customer selects an interactive feature 410 which represents an indication (e.g., “My Giftlist”) that the customer wants to begin shopping using a recipient list created from a previous periodic event transaction. The interactive feature offering access to a periodic event list can be placed in many resources 410, 506. In this example, a periodic event list is returned based on the season (time of year) the customer selects the interactive feature 410. A resource 1200 is returned to the customer which includes a previous periodic event list transaction (gift list) 1202, but also includes an interactive feature 1204 for selecting other previous periodic event lists. In this example, the customer stays with default list 1202.

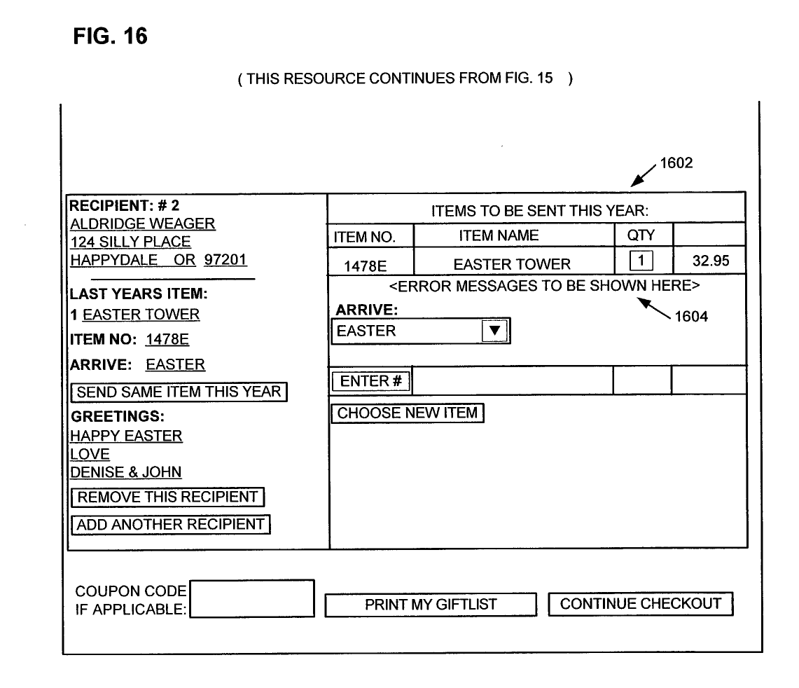

In one example, a recipient list includes an interactive feature 1208 for indicating that the same item sent to a recipient last year should be sent to that recipient again this year. In such an example, if this interactive feature 1208 is selected by the customer, last years product description information automatically populates the fields 1802 indicating that the same product will be sent again this year as shown in FIG. 18. However, this interactive feature 1208 only populates “Items To Be Sent This Year” 1802 for the one recipient 1804, and not the other recipients on the list. Selecting this interactive feature 1208 does not alter the interactive feature text or functionality of the interactive feature 1806 titled “Click To Send Everything the Same as Last Year.”

In another example, a recipient list includes an interactive feature 1210 that upon selection by a customer, removes a recipient from this periodic recipient list 1202. In one implementation, that recipient also may be automatically removed from the customer's address book.

In another example, a recipient list includes an interactive feature 1212 that upon selection by a customer, presents a resource 1100 to the customer for adding a recipient to this periodic recipient list as shown in exemplary FIG. 11. In such a case, the new recipient is added to the recipient list 1902 as shown in exemplary FIG. 19. In one case, information typed into the customer resource 1100 (e.g., name and address and greeting) is transferred into the new recipient cell 1901, (e.g., 1902, 1908). In this case, a customer uses an interactive feature 1906 to shop for a new product for the new recipient. A selected new product 1904 is associated with the new recipient 1902 in the new cell 1901. Also notice, since this recipient is associated with a periodic event (e.g., Easter), in one alternative, an interactive feature containing a default delivery date 1912 is set for the new recipient cell 1901.

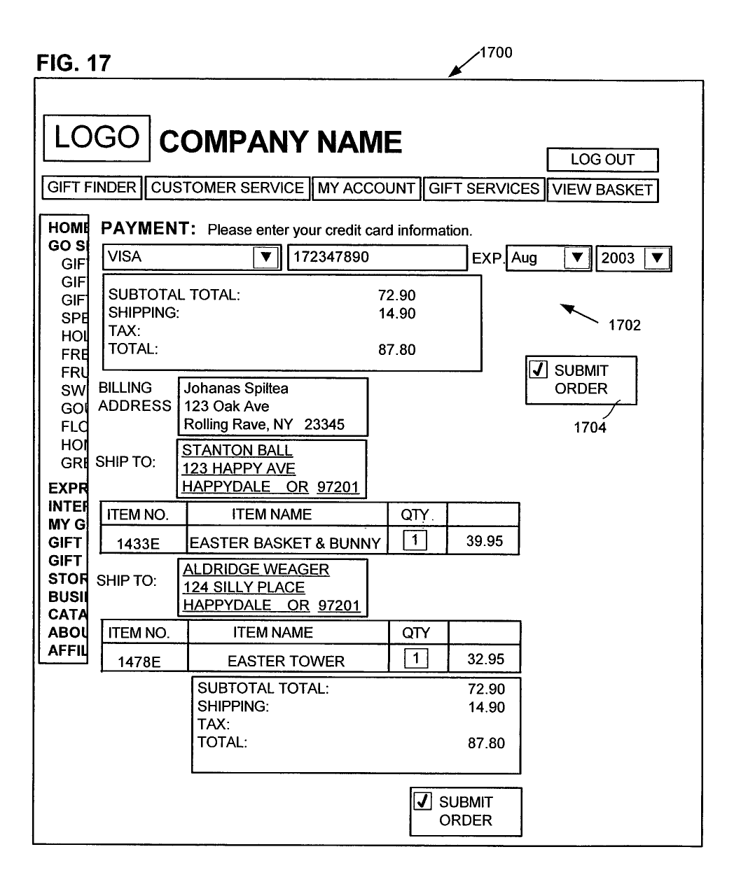

In another example, a recipient list includes an interactive feature 1302 which allows a customer to shop for a product (or an additional product) for this 1304 recipient. Upon selecting this interactive feature 1302, a resource 2000 is presented to the customer for shopping for this 1304 recipient within the context of this periodic event recipient list 2002 as shown in exemplary FIG. 20. As such, when a customer selects a product 2004 using this resource 2000, the selected product 2006 is automatically associated 1914 with the recipient 1916.

While shopping for a recipient 2008, on this recipient list 1800, a customer may identify a product that the customer wants to select for another recipient on the recipient list 1804, 1902, a recipient not currently on the recipient list (e.g., someone in the address book), or for themselves. In such a case, a resource 2010 is provided for changing who the customer is shopping for. For example, if the customer selects “ME” 2020 using the interactive feature 2010, upon selecting a product 2004, the recipient list will include an interactive feature 1918 indicating that other products have been selected. If the customer selects “Stanton Ball” or “Alice Newrite” 2014 (other recipients on this 1800 recipient list) and then selects a product 2004, the selected product will be added to the “Items to Be Sent This Year” for that list recipient. Notice also, the customer can select any recipient from the customers address book 2016. If the customer selects a customer from “My Address Book” 2016 and then selects a product 2004, that recipient from “My Address Book” will be added to this recipient list including the selected product. Upon selecting a recipient from the pull-down abbreviated version of the address book 2016, that recipient will be added to this recipient list 1800 and the selected product 2004 will appear in the “Items to Be Sent This Year” for the selected recipient 2016. If the customer writes-in a “New Recipient” 2018, and then selects a product 2004, the customer will be presented with a resource 1100 for adding a new recipient to this recipient list 1800, and the selected product 2004, will appear in the “Items to Be Sent This Year” for the added recipient.

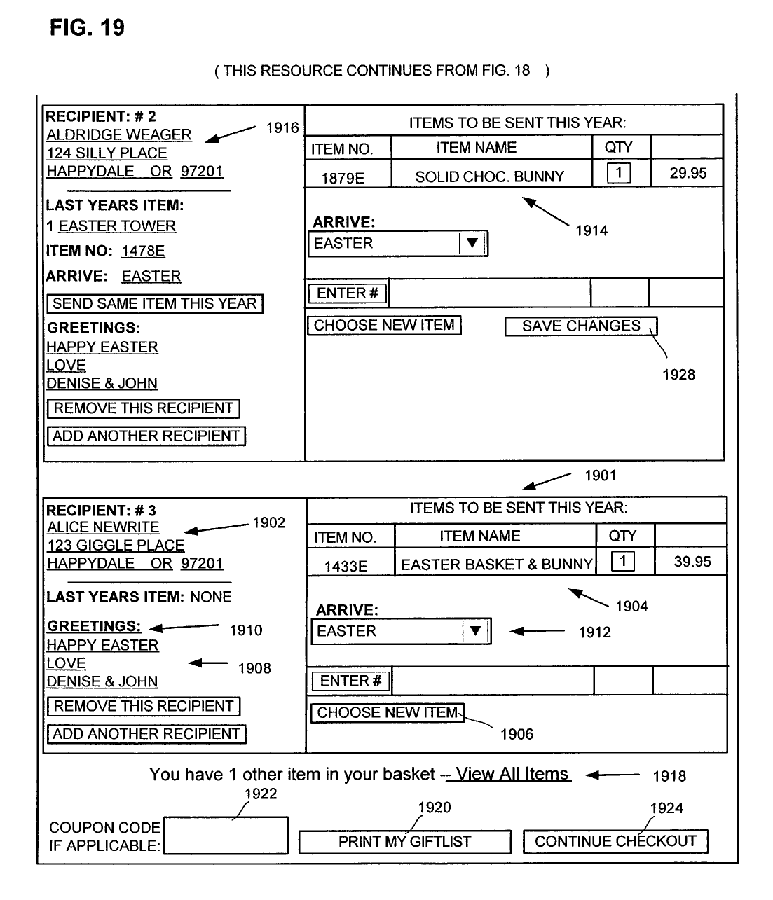

In another example, a recipient list recipient cell 2100 includes an interactive feature 2102 which allows a customer to select a recommend replacement product 2106 when a product sent last year 2104 is no longer available. Upon selecting an interactive feature 2102 indicating the recommended product, the product description automatically populates the interactive field “Items to Be Sent This Year” 2204 for this recipient as shown 2200 in exemplary FIG. 22.

In another example, a recipient list recipient cell 2100 includes an interactive feature 2108 which allows a customer to enter a product item number for a desired product for this recipient 2100. Upon entering a product item number (e.g., 3421E) in the interactive field 2108, upon a server page refresh, a product description and price populates the recipient cell as shown 2206 in exemplary FIG. 22. Further, the delivery date defaults to the date 2208 for this periodic event recipient list. The product item number can be obtained from a number of sources. For example, the product item number may be obtained from a catalogue received by the customer in the mail, a product description contained in an e-commerce description (e.g., FIG. 20, 2006), or an item number in another recipient's cell 2106, etc.

In another example, a recipient list recipient cell 2200 includes an interactive feature 2210 which allows a customer to enter a quantity for the number of the selected items the customer wants to send to this recipient (e.g., maybe the customer wants to send a product item to each of the recipient's children or employees). If the customer selects this interactive feature 2210, and types in the quantity three (3), then three of these 2206 items will be sent to this recipient, and the price 2212 will adjust accordingly (e.g., 3x). If the customer types zero (0) into this interactive feature 2210, then zero of this 2204 item will be purchased.

In another example, a recipient list recipient cell 2100 includes an interactive feature 2110 which returns another resource 1100 for changing the name or mailing address of a recipient. Upon saving the changes 1114, the new recipient information appears in the recipient's cell 2110.

In another example, a recipient list includes an interactive feature 1922 that a customer can use to enter a coupon code. The coupon code can be obtained by the customer from a number of sources. For example, a printed catalogue may offer coupons, an on-line catalogue may offer coupons 210, 802, 2006, an e-mail from the company to the customer may offer coupons, or a gift certificate may function as a coupon 2012, etc.

In another example, once changes have been made to a recipient cell, an interactive feature 1928 appears. Using this interactive feature 1928, a customer can save these changes to this recipient list 1800 so upon a next visit to this server resource, the changes are not lost. Also, if a customer selects an interactive feature 1808 to close a periodic event recipient list (giftlist), a any changes made to the giftlist during the session are saved.

In one example, a recipient list includes an interactive feature for printing the recipient list 1920.

In one example, once changes are made to the recipient list, a customer may select an interactive feature 1924 that returns a check out resource (e.g., as shown in exemplary FIG. 17). In this case, the reorder submission 1704 will include any recipient changes and associated product changes made to the periodic event recipient list.

### Recipient List Oriented Shopping—Additional Features

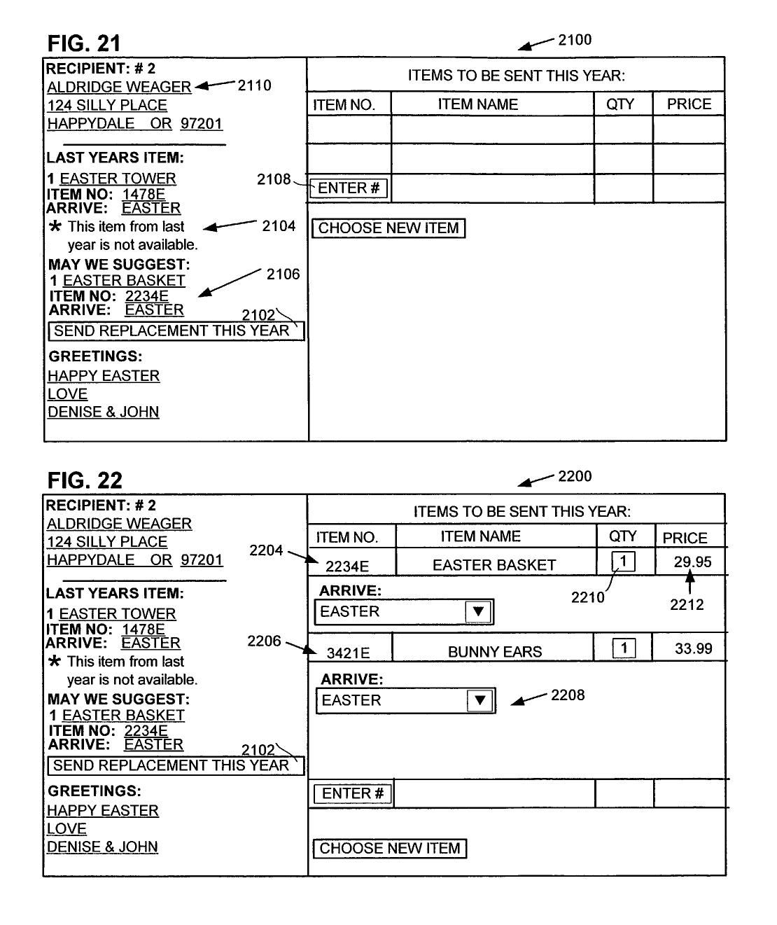

In this example, a recipient cell 2300 includes an interactive feature 2308 for selecting a delivery date. In this case, when the interactive feature is selected, a resource 2402 presenting delivery choices is displayed 2408 to the customer as shown in exemplary FIG. 24. The customer uses this interactive feature 2408 to select a delivery date. In one case the interactive feature 2308 is initially populated with a default delivery date, as previously discussed. In other cases, the interactive feature assumes immediate delivery until another date is selected. In other case, the interactive feature is presented upon a product selection 2402, and contains no default date.

In this example, a customer selects from among plural available delivery dates and methods 2408 as shown in exemplary FIG. 24. Based upon the selected date, the system determines whether or not the selected item is deliverable by that date.

In one such case, the system makes this determination using a standard delivery method. For example, it may be determined that the standard delivery service will not deliver the selected product by the selected. In such a case, a resource 2502 indicates that an alternative delivery method is available that will deliver by the requested date, and presents the alternative method to the customer.

In another case, a customer selects a delivery method 2410, and a resource 2600 is presented containing the date 2602 the product will be delivered according to the selected method.

In another case, a customer selects a specific date 2702 for delivery, and the system determines a delivery method 2704 that meets the desired date.

In an alternative embodiment, an interactive feature 2706 is provided that allows sending this same product 2708 to another, or to a new recipient. If this interactive feature is selected 2706, a customer is next presented with a resource that allows selecting another recipient on the recipient list (e.g., 2014), another recipient not on the recipient list but in the address book (e.g., 2016), or a new recipient write-in (e.g., 2018 or 1100). If the selected recipient is already in the recipient list, the same product is added to that recipients “Items to Be Sent This Year.” If the recipient is new, or from the address book, a new recipient cell is added to the recipient list, and the new cell includes the new or selected recipient along with the same product 2708 appearing in the “Items to Be Sent This Year.”

A recipient list can be compiled from a previous transaction, multiple previous transactions, and or the customer's address book. For example as previously explained, the company may compile a list or previous transactions into a customers address book. The company can compile a recipient list, and include recipients from the customers address book or other order transactions into the recipient list. For example, if a customer orders an Easter gift for a recipient (e.g. Donna), a subsequent recipient list (e.g., Halloween gift list) may include Donna even though Donna was not sent anything for Halloween by the customer last year. For example, a recipient list could contain every recipient in a customers address book.

### Web Pages and Web Page Templates

In one example, the server resources are supported as hyper-text mark-up language pages (e.g., web pages). Upon receiving a network request from a client device, the server streams a hyper-text mark-up file across the network to the client device. The client device contains web browser software, which receives and parses the file, and presents a representation of the file on-screen in a browser window. The hyper-text mark-up language file is a source code file that describes both the page content and the page layout. The web browser receives the source code file and presents the web page content and layout according to the source code file content and description. Thus, the source code file is stored in memory at the server before being streamed across the network to the client device. Further, the source code file is stored in memory at the client as it is received and parsed into the on-screen web page representation.

For example, FIG. 6 is a web page representation of a source code file received from a server and presented on-screen at the client device. The text and boxes viewed in FIG. 6 are graphical representations of web page content described by the source code. Not visible in FIG. 6, are the hyper-text mark-up language directives and scripts used to control how content is displayed and dynamically alterable on the page. However, these directives and scripts are not belabored here because they are known in the art. See “Teach Yourself Web Publishing With HTML 3.0 in A Week,” Second Edition, Sam.net Publishing, 1996.

In one example, web page templates are used at the server to support customized web pages. For example, portions of FIG. 6 are presented to all customers who request their address book, while other portion are customer specific. For example, in FIG. 6, only the shipping addresses and names are specific to a customer, and all other content is reused for other customers. In this case, the source code describing all the layout, and all the content (except the names and addresses) are stored in a web page template at the server for reuse. Upon client device request for this web page resource 600, the server starts with the template and then adds the names and addresses before streaming the source code file to the customer.

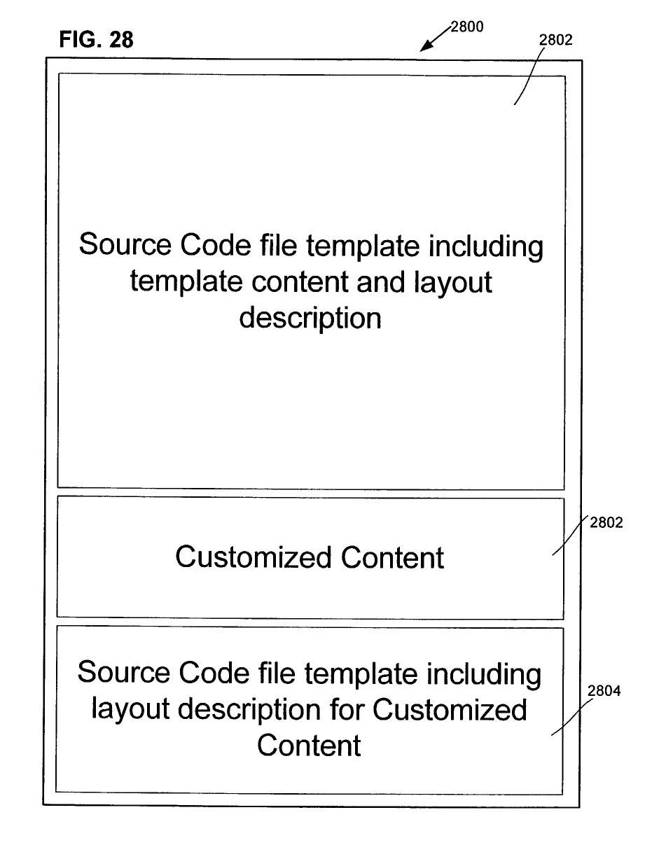

FIG. 28 is a diagram of a source code file of FIG. 6, representing the areas 2800 of an exemplary hyper-text mark-up language source code template. The template file includes a description of web page content and the desired layout for the portions that can be reused 2802. The template optionally includes 2806 the layout descriptions for the customized content. The server starts with these portions 2802, 2804, and adds the customized names 2804, to create the completed source code file that is streamed to the client device. Using templates in web page customization is known in the computer arts, and thus are not belabored further here (e.g., Active Server Pages, from Microsoft Corporation).

In this case, templates holding server hyper-text mark-up language content (e.g., address book templates, recipient list templates, shopping basket templates, etc.) are held in server memory. The server starts with the template 2802, 2806, and adds the customized content 2804 to the source code description. The completed customized source code files are assembled in server memory as or while they are streamed to the client device. Further, the completed source code files are received in client device memory as they are parsed and presented on-screen to a customer. These source code files and templates are contained or stored in computer readable memory such as main memory, storage devices, or portable memory (e.g., hard drives, secondary storage devices, databases, CDs, floppy disks, tapes, etc.).

### Rapid Reorders

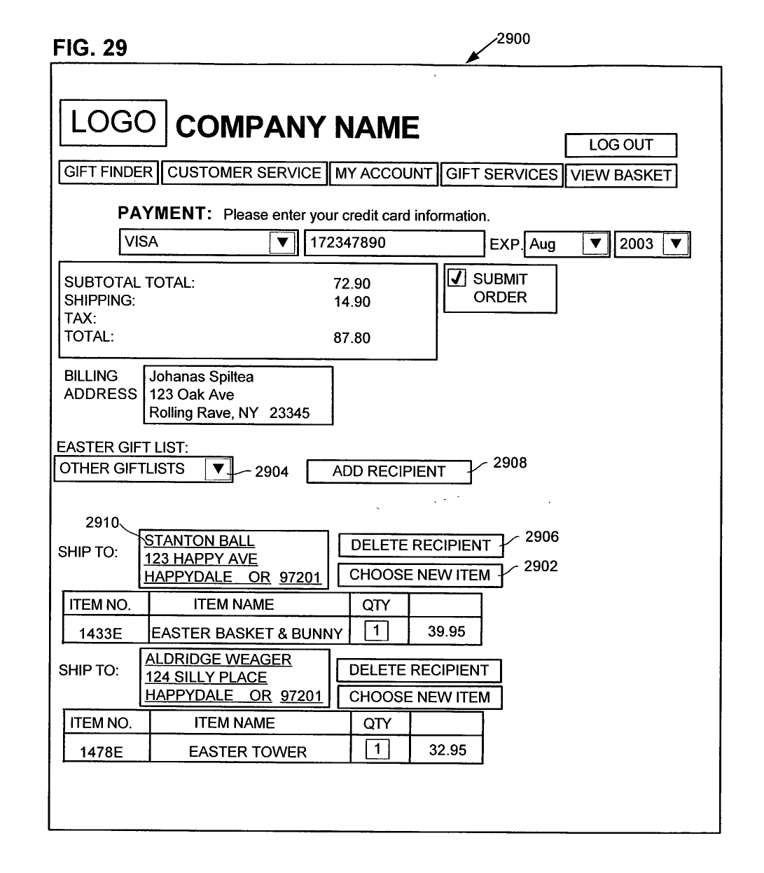

In an alternative implementation, an e-mail to a customer provides a rapid access to a reorder web page for sending the same item to the same recipients. For example, an e-mail containing a link is sent by the company to the customer. If the customer selects the link embedded in the e-mail, a web page resource containing a recipient list is presented to the customer in a web browser. The link in the e-mail includes information identifying the customer, so that upon accessing the web resource, the recipient list is displayed. For example, as shown in exemplary FIG. 17, the web page includes a list of recipients, items to be sent to the recipients in association with a holiday, and credit card information used in a previous purchase 1702. The customer then merely needs to select a submit order button 1704. In a variation of this example, the web page includes an interactive feature 2902 as shown in FIG. 29, that the customer can select to choose another or an additional item for the associated recipient.

In another example, an interactive feature in a web page provides rapid access to a reorder web page for sending the same items to the same recipients. For example, a customer browses to a company web page shown in exemplary FIG. 4 and is identified by the remember-me feature. The customer selects the interactive feature 410 indicating a giftlist request, and the exemplary web pages shown in FIG. 17 or FIG. 29 are presented in response thereto. In one such case, the server defaults to the customers giftlist based on the date of the request. Additional interactive features can be provided alone or in combination, that allow a customer to change giftlists 2904, add recipients to the giftlist 2908, or delete an associated recipient 2906.

Using these rapid reorder examples, and or other combinations of the interactive features disclosed herein, a customer reorder experience is greatly enhanced.

Having described and illustrated the principles of our invention with reference to an illustrated embodiment, it will be recognized that the illustrated embodiment can be modified in arrangement and detail without departing from such principles. It should be understood that the programs, processes, or methods described herein are not related or limited to any particular type of computer apparatus, unless indicated otherwise. Various types of general purpose or specialized computer apparatus may be used with or perform operations in accordance with the teachings described herein. Elements of the illustrated embodiment shown in software may be implemented in hardware and vice versa.

In view of the many possible embodiments to which the principles of our invention may be applied, it should be recognized that the detailed embodiments are illustrative only and should not be taken as limiting the scope of our invention. Rather, we claim as our invention all such embodiments as may come within the scope and spirit of the following claims and equivalents thereto.

We claim:

1. A method for computerized recipient list oriented item selection and purchase, including editable recipient lists associated with customer identifications, and items for selection by customers in association with recipients on a recipient list, the method comprising:
receiving an editable recipient list associated with a customer;
presenting the editable recipient list listing,
plural recipients previously sent items selected by the customer, and
associated with each recipient,
a previous item, and
a shop-for-this-recipient interactive feature;
in response to receiving a selection of a shop-for-this-recipient interactive feature associated with a specific recipient, presenting items for selection and an item selection interactive feature;
in response to receiving a selection of the item selection interactive feature, presenting the editable recipient list, comprising the selected item associated with the specific recipient.

2. A network shopping site offering both product oriented and recipient oriented shopping modes, the system comprising:
a server for receiving requests from networked clients;
software executing on the server in response to receiving a network client request, the software responding to and completing network purchase order requests comprising,
product oriented shopping requests comprising, a product browsing and selection request followed by a request to ship a selected product to a recipient, comprising the recipient's name and address; and
recipient list oriented shopping requests comprising,
a request for a recipient list containing one or more recipients previously sent products by a customer,
one or more product browsing requests, and
a returned recipient list transaction request comprising one or more associations, each association comprising a recipient from the recipient list associated with a product from a browsing request.

3. A method for computerized recipient list reorders comprising:
sending a request comprising an identifier;
receiving in response to the request, a recipient list associated with the identifier, the recipient list comprising a send as-is interactive feature and plural recipients sent products in response to a previous order made by a customer associated with the identifier, each recipient on the list having a name, an address, a previously-sent product identification, and a field for holding a send-next product identifier;
displaying the recipient list; and
in response to receiving an indication that the send as-is interactive feature was selected, displaying the recipient list wherein for each recipient, the field for holding a send-next product identifier contains the previously-sent product identification.

4. A computerized reorder method, comprising:
transmitting from a client, a request comprising an identifier;
receiving at the client in response to the request, a recipient list comprising a list of one or more recipients previously shipped one or more items selected by a customer in a prior transaction;
presenting on-screen at the client, the recipient list comprising,
a recipient list transaction acceptance interactive feature, and
for each recipient on the list,
a name and an address for that recipient,
an identification of an item previously shipped to that recipient,
a send the previously shipped item again interactive feature,
a browse items for this recipient interactive feature, and
a field for displaying items to be shipped to this recipient.

5. The method of claim 4 wherein the identifier identifies the customer.

6. The method of claim 4, wherein the identifier identifies at least one prior on-line transaction.

7. The method of claim 4, wherein the identifier identifies the recipient list.

8. The method of claim 7, wherein the recipient list is associated with a holiday.

9. The method of claim 4, further comprising:
transmitting from the client, a recipient list transaction acceptance request in response to a selection of the recipient list transaction acceptance interactive feature.

10. The method of claim 9 wherein one or more of the same one or more items shipped in response to the recipient list transaction acceptance request festively varies from what was previously shipped.

11. The method of claim 4, wherein upon receiving a selection of the send the previously shipped item again interactive feature for a given recipient, the same item is displayed in the field for displaying items to be shipped to this recipient.

12. The method of claim 4, wherein the on-screen presented recipient list further comprises for at least one recipient on the list, an indication that an item previously shipped to that recipient is an unavailable item.

13. The method of claim 12, wherein the on-screen presented list further identifies a suggested item for sending in place of the unavailable item.

14. A computer readable storage medium containing instructions for a computerized reorder method, comprising:
transmitting from a client, a request comprising an identifier;
receiving at the client in response to the request, a recipient list comprising a list of one or more recipients, each previously shipped one or more items selected by a customer in a prior on-line transaction;
presenting on-screen at the client, the recipient list comprising,
a recipient list transaction acceptance interactive feature, and
for each recipient on the list,
a name and an address for that recipient,
an identification of an item previously shipped to that recipient,
a browse items for this recipient interactive feature, and
a field for displaying items to be shipped to this recipient;
receiving from an input device at the client, an indication requesting changes to the presented on-screen recipient list;
presenting on-screen at the client, the recipient list comprising changes made according to the indication;
transmitting a recipient list aggregate transaction acceptance comprising the changes made according to the indication, in response to a selection of the recipient list transaction acceptance interactive feature.

15. The computer readable storage medium of claim 14, wherein the indication comprises a request to add a recipient to the recipient list.

16. The computer readable storage medium of claim 12, wherein the indication comprises a request to change the address of a recipient.

17. The computer readable storage medium of claim 14, wherein the recipient list comprises a greeting for at least on recipient, and the indication comprises a request to change the greeting.

18. The computer readable storage medium of claim 14, wherein the recipient list comprises an item browsing interactive feature, and the indication comprises an identification of one or more browsed items.

19. The computer readable storage medium of claim 18, wherein the indication of the browsed item is associated with more than one recipient on the recipient list.

20. The computer readable storage medium of claim 14 further comprising:
presenting on-screen at the client, a recipient list selection interactive feature for selecting from among plural recipient lists associated with the customer.

21. The computer readable storage medium of claim 20, wherein at least two of the recipient lists are gift lists associated with a holiday.

22. The computer readable storage medium of claim 14, wherein the recipient list comprises an item number identification field, and a printed catalogue of items comprises an identification number associated with each item in the catalogue, and the indication comprises an identification number associated with the item number identification field.

23. The computer readable storage medium of claim 14, wherein the recipient list comprises a quantity field signifying the number of a same item being sent to a specific recipient, and the indication comprises a number associated with the quantity field.

24. A computer system comprising:
a server for processing requests from networked client devices;
a database coupled to the server containing information about customers and transactions; and
server software for creating and returning web pages comprising recipient lists with plural recipients on each recipient list, and for each recipient on a list,
an interactive feature for selecting the same item as last year for the recipient, and
an interactive feature for shopping-for a new item this year for the recipient.

25. The system of claim 24, further comprising:
server software for,
receiving product browsing requests; and
receiving recipient list transaction requests.

26. The system of claim 24, further comprising:
server software for,
associating an identifier of a customer with a recipient list; and
adding an address book recipient to a recipient list.

27. The system of claim 24, further comprising:
server software for,
determining whether a requested delivery date is feasible for a given recipient; and
offering additional shipping choices.

28. A computer readable medium having source code describing a recipient list reorder page comprising:
a list of recipients previously sent products; and
for each recipient on the list,
a description of a product previously sent to the recipient;
a description of an interactive feature used to reorder the product previously sent to the recipient, and
a description of an interactive feature used to request browsing for a new product this year for the recipient.

29. A computer readable medium having a template describing a recipient list reorder web page comprising:
standard content for the web page;
a description indicating the location of customized content for the web page; and
a description of the per recipient layout with a product previously sent to the recipient, an interactive feature used to reorder the product previously sent to the recipient, and an interactive feature used to request browsing for a new product this year for the recipient.
